(19) United States
(12) Patent Application Publication
(10) Pub. No.: US 2022/0331755 A1
(43) Pub. Date: Oct. 20, 2022

(54) ULTRA-FINE BUBBLE-CONTAINING LIQUID MANUFACTURING APPARATUS

(71) Applicant: CANON KABUSHIKI KAISHA, Tokyo (JP)

(72) Inventors: Hiroyuki Shimoyama, Hyogo (JP); Masahiko Kubota, Tokyo (JP); Hiroaki Mihara, Tokyo (JP); Akira Yamamoto, Kanagawa (JP); Ikuo Nakazawa, Kanagawa (JP); Toshio Kashino, Kanagawa (JP)

(21) Appl. No.: 17/690,248

(22) Filed: Mar. 9, 2022

(30) Foreign Application Priority Data
Apr. 14, 2021 (JP) 2021-068600

(51) Int. Cl. B01F 23/80; B01B 1/00; B01F 23/2375; B01F 23/237; B01F 23/231; H05B 3/82

(52) U.S. Cl. CPC B01F 23/811; B01B 1/00; B01F 23/2375; B01F 23/237612; B01F 23/231; B01F 23/812; B01F 23/808; H05B 3/82; B01F 23/703

(57) ABSTRACT

Provided is an ultra-fine bubble-containing liquid manufacturing apparatus that can suppress viable cell contamination inside a UFB generating unit. To this end, it is provided with an ultra-fine bubble generating unit that generates an ultra-fine bubble by making film boiling by a heating unit in a liquid in which a gas is dissolved, and a radiating unit that is capable of irradiating a wetted portion of the ultra-fine bubble generating unit with ultraviolet rays.

### BACKGROUND OF THE INVENTION

### Field of the Invention

The present invention relates to an ultra-fine bubble-containing liquid manufacturing apparatus.

### Description of the Related Art

Japanese Patent Laid-Open No. 2019-42664 describes a UFB generating apparatus that makes film boiling in a liquid by using a heat energy generating element and collects the liquid containing ultra-fine bubbles (hereinafter, also referred as “UFBs”) generated by the film boiling.

### SUMMARY OF THE INVENTION

The present invention is an ultra-fine bubble-containing liquid manufacturing apparatus, including: an ultra-fine bubble generating unit that generates an ultra-fine bubble by making film boiling by a heating unit in a liquid in which a gas is dissolved; and a first radiating unit that is capable of irradiating a wetted portion of the ultra-fine bubble generating unit with ultraviolet rays.

Further features of the present invention will become apparent from the following description of exemplary embodiments with reference to the attached drawings.

### BRIEF DESCRIPTION OF THE DRAWINGS

FIG. 1 is a diagram illustrating an example of a UFB generating apparatus;

FIG. 2 is a schematic configuration diagram of a pre-processing unit;

FIG. 3A is a schematic configuration diagram of a dissolving unit;

FIG. 3B is a diagram for describing dissolving states of a liquid;

FIG. 4 is a schematic configuration diagram of a T-UFB generating unit;

FIG. 5A is a diagram illustrating a detailed configuration of a heating element;

FIG. 5B is a diagram illustrating a detailed configuration of the heating element;

FIG. 6A is a diagram illustrating states of film boiling in a case where a predetermined voltage pulse is applied to the heating element;

FIG. 6B is a diagram illustrating the states of film boiling in a case where a predetermined voltage pulse is applied to the heating element;

FIG. 7A is a diagram illustrating a state in which UFBs are generated along with generation and expansion of a film boiling bubble;

FIG. 7B is a diagram illustrating a state in which the UFBs are generated along with generation and expansion of the film boiling bubble;

FIG. 7C is a diagram illustrating a state in which the UFBs are generated along with generation and expansion of the film boiling bubble;

FIG. 7D is a diagram illustrating a state in which the UFBs are generated along with generation and expansion of the film boiling bubble;

FIG. 8A is a diagram illustrating a state in which the UFBs are generated along with shrinkage of the film boiling bubble;

FIG. 8B is a diagram illustrating a state in which the UFBs are generated along with shrinkage of the film boiling bubble;

FIG. 8C is a diagram illustrating a state in which the UFBs are generated along with shrinkage of the film boiling bubble;

FIG. 9A is a diagram illustrating a state in which the UFBs are generated by reheating the liquid;

FIG. 9B is a diagram illustrating a state in which the UFBs are generated by reheating the liquid;

FIG. 9C is a diagram illustrating a state in which the UFBs are generated by reheating the liquid;

FIG. 10A is a diagram illustrating a state in which the UFBs are generated by an impact from disappearance of the film boiling bubble;

FIG. 10B is a diagram illustrating a state in which the UFBs are generated by the impact from disappearance of the film boiling bubble;

FIG. 11A is a diagram illustrating a configuration example of a post-processing unit;

FIG. 11B is a diagram illustrating a configuration example of the post-processing unit;

FIG. 11C is a diagram illustrating a configuration example of the post-processing unit;

FIG. 12 is a schematic configuration diagram illustrating a UFB generating apparatus;

FIG. 13 is a diagram illustrating a UFB generating unit irradiated with ultraviolet rays;

FIG. 14A is a diagram illustrating the UFB generating unit;

FIG. 14B is a diagram illustrating the UFB generating unit;

FIG. 15 is a schematic configuration diagram illustrating a UFB generating apparatus;

FIG. 16 is a schematic configuration diagram illustrating a UFB generating apparatus;

FIG. 17A is a schematic configuration diagram illustrating a UFB generating apparatus; and

FIG. 17B is a schematic configuration diagram illustrating the UFB generating apparatus.

### DESCRIPTION OF THE EMBODIMENTS

Due to viable cells mixed into a UFB generating apparatus, there is a risk of occurrence of viable cell contamination of a UFB-containing liquid itself and viable cell contamination of the inside of a UFB generating unit. If the viable cell contamination occurs inside the UFB generating unit, it can be considered that the viable cells may be attached to a fine heat energy generating element in the UFB generating unit and a bubbling chamber formed to cover the heat energy generating element, and a colony may be formed by proliferation. Consequently, there is a risk of having bad effects on the air bubble generation that is the basis for the UFB generation.

To deal with this, the present invention provides an ultra-fine bubble-containing liquid manufacturing apparatus capable of suppressing viable cell contamination inside a UFB generating unit.

### First Embodiment

A first embodiment of the present invention is described with reference to the drawings.

### <<Configuration of UFB Generating Apparatus>>

The schematic description of a UFB generating apparatus utilizing film boiling phenomenon is given below.

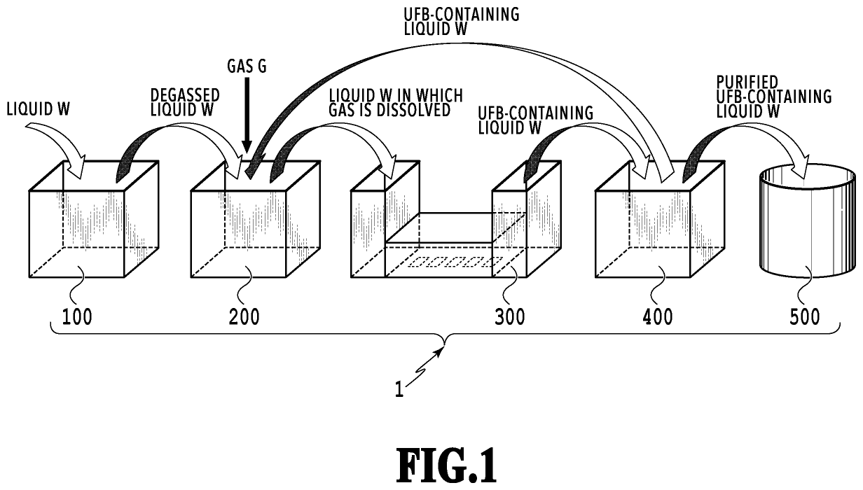

FIG. 1 is a diagram illustrating an example of the UFB generating apparatus applicable to the present embodiment. A UFB generating apparatus 1 of this embodiment includes a pre-processing unit 100, dissolving unit 200, a T-UFB generating unit 300, a post-processing unit 400, and a collecting unit 500. Each unit performs unique processing on a liquid W such as tap water supplied to the pre-processing unit 100 in the above order, and the thus-processed liquid W is collected as a T-UFB-containing liquid by the collecting unit 500. Functions and configurations of the units are described below. Although details are described later, UFBs generated by utilizing the film boiling caused by rapid heating are referred to as thermal-ultrafine bubbles (T-UFBs) in this specification.

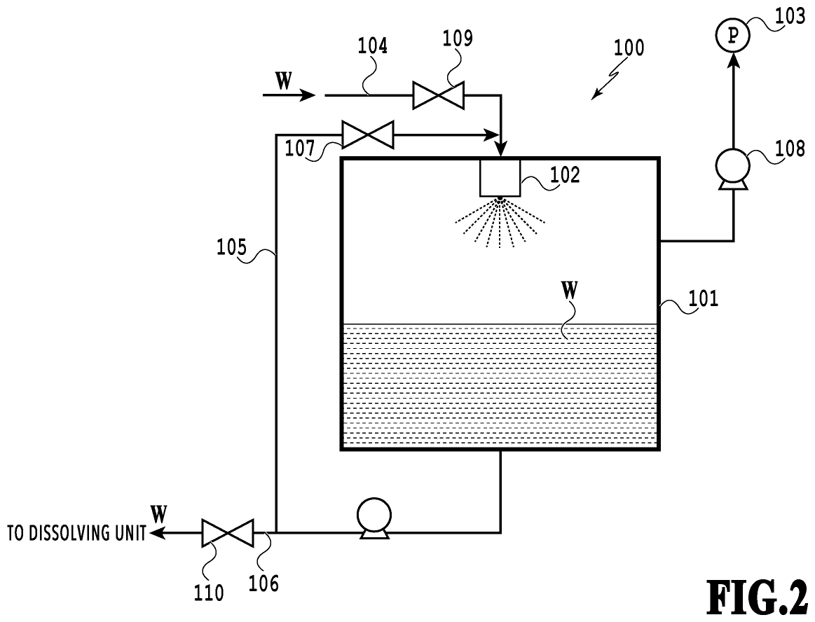

FIG. 2 is a schematic configuration diagram of the pre-processing unit (degassing unit) 100. The pre-processing unit 100 of this embodiment performs a degassing treatment on the supplied liquid W. The pre-processing unit 100 mainly includes a degassing container 101, a shower head 102, a depressurizing pump 103, a liquid introduction passage 104, a liquid circulation passage 105, and a liquid discharge passage 106. For example, the liquid W such as tap water is supplied to the degassing container 101 from the liquid introduction passage 104 through a valve 109. In this process, the shower head 102 provided in the degassing container 101 sprays a mist of the liquid W in the degassing container 101. The shower head 102 is for prompting the gasification of the liquid W; however, a centrifugal and the like may be used instead as the mechanism for producing the gasification prompt effect.

When a certain amount of the liquid W is retained in the degassing container 101 and then the depressurizing pump 103 is activated with all the valves closed, already-gasified gas components are discharged, and gasification and discharge of gas components dissolved in the liquid W are also prompted. In this process, the internal pressure of the degassing container 101 may be depressurized to around several hundreds to thousands of Pa (1.0 Torr to 10.0 Torr) while checking a manometer 108. The gases to be removed by the degassing unit 100 includes nitrogen, oxygen, argon, carbon dioxide, and so on, for example.

The above-described degassing processing can be repeatedly performed on the same liquid W by utilizing the liquid circulation passage 105. Specifically, the shower head 102 is operated with the valve 109 of the liquid introduction passage 104 and a valve 110 of the liquid discharge passage 106 closed and a valve 107 of the liquid circulation passage 105 opened. This allows the liquid W retained in the degassing container 101 and degassed once to be resprayed in the degassing container 101 from the shower head 102. In addition, with the depressurizing pump 103 operated, the gasification processing by the shower head 102 and the degassing processing by the depressurizing pump 103 are repeatedly performed on the same liquid W. Every time the above processing utilizing the liquid circulation passage 105 is performed repeatedly, it is possible to decrease the gas components contained in the liquid W in stages. Once the liquid W degassed to a desired purity is obtained, the liquid W is transferred to the dissolving unit 200 through the liquid discharge passage 106 with the valve 110 opened.

FIG. 2 illustrates the degassing unit 100 that depressurizes the gas part to gasify the solute; however, the method of degassing the solution is not limited thereto. For example, a heating and boiling method for boiling the liquid W to gasify the solute may be employed, or a film degassing method for increasing the interface between the liquid and the gas using hollow fibers. A SEPAREL series (produced by DIC corporation) is commercially supplied as the degassing module using the hollow fibers. The SEPAREL series uses poly(4-methylpentene-1) (PMP) for the raw material of the hollow fibers and is used for removing air bubbles from ink and the like mainly supplied for a piezo head. In addition, two or more of an evacuating method, the heating and boiling method, and the film degassing method may be used together.

With the above-described degassing processing performed as pre-processing, it is possible to increase the purity and the solubility of a desired gas with respect to the liquid W in the dissolving processing described later. Additionally, it is possible to increase the concentration of desired UFBs contained in the liquid W in the T-UFB generating unit described later. That is, it is possible to efficiently generate a UFB-containing liquid with high concentration by providing the pre-processing unit 100 to precede the dissolving unit 200 and the T-UFB generating unit 300.

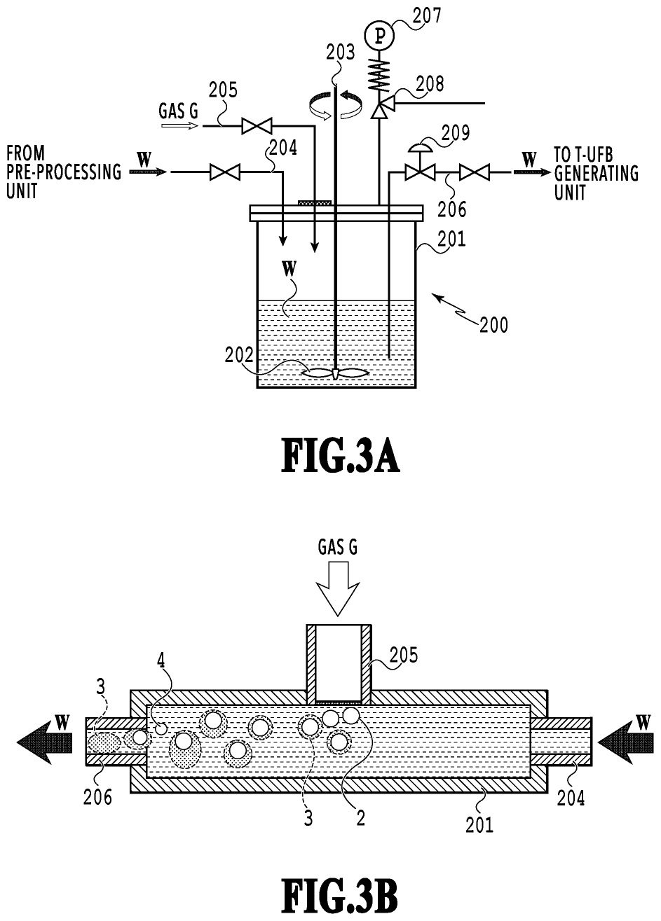

FIGS. 3A and 3B are a schematic configuration diagram of the dissolving unit 200 and a diagram for describing the dissolving states in the liquid. The dissolving unit 200 is a unit for dissolving a desired gas into the liquid W supplied from the pre-processing unit 100. The dissolving unit 200 of this embodiment mainly includes a dissolving container 201, a rotation shaft 203 provided with a rotation plate 202, a liquid introduction passage 204, a gas introduction passage 205, a liquid discharge passage 206, and a pressurizing pump 207.

The liquid W supplied from the pre-processing unit 100 is supplied and retained into the dissolving container 201 through the liquid introduction passage 204. Meanwhile, a gas G is supplied to the dissolving container 201 through the gas introduction passage 205.

Once predetermined amounts of the liquid W and the gas G are retained in the dissolving container 201, the pressurizing pump 207 is activated to increase the internal pressure of the dissolving container 201 to about 0.5 MPa. A safety valve 208 is arranged between the pressurizing pump 207 and the dissolving container 201. With the rotation plate 202 in the liquid rotated via the rotation shaft 203, the gas G supplied to the dissolving container 201 is transformed into air bubbles, and the contact area between the gas G and the liquid W is increased to prompt the dissolution into the liquid W. This operation is continued until the solubility of the gas G reaches almost the maximum saturation solubility. In this case, a unit for decreasing the temperature of the liquid may be provided to dissolve the gas as much as possible. When the gas is with low solubility, it is also possible to increase the internal pressure of the dissolving container 201 to 0.5 MPa or higher. In this case, the material and the like of the container need to be the optimum.

Once the liquid W in which the components of the gas G are dissolved at a desired concentration is obtained, the liquid W is discharged through the liquid discharge passage 206 and supplied to the T-UFB generating unit 300. In this process, a back-pressure valve 209 adjusts the flow pressure of the liquid W to prevent excessive increase of the pressure during the supplying.

FIG. 3B is a diagram schematically illustrating the dissolving states of the gas G put in the dissolving container 201. An air bubble 2 containing the components of the gas G put in the liquid W is dissolved from a portion in contact with the liquid W. The air bubble 2 thus shrinks gradually, and a gas-dissolved liquid 3 then appears around the air bubble 2. Since the air bubble 2 is affected by the buoyancy, the air bubble 2 may be moved to a position away from the center of the gas-dissolved liquid 3 or be separated out from the gas-dissolved liquid 3 to become a residual air bubble 4. Specifically, in the liquid W to be supplied to the T-UFB generating unit 300 through the liquid discharge passage 206, there is a mix of the air bubbles 2 surrounded by the gas-dissolved liquids 3 and the air bubbles 2 and the gas-dissolved liquids 3 separated from each other.

The gas-dissolved liquid 3 in the drawings means “a region of the liquid W in which the dissolution concentration of the gas G mixed therein is relatively high.” In the gas components actually dissolved in the liquid W in either case where the gas-dissolved liquid 3 is surrounding the air bubble 2 or separated from the air bubble 2, the concentration of the gas components in the center of the region is the highest, and the concentration is continuously decreased as away from the center. That is, although the region of the gas-dissolved liquid 3 is surrounded by a broken line in FIG. 3B for the sake of explanation, such a clear boundary does not actually exist. In addition, in the present embodiment, a gas that cannot be dissolved completely may be accepted to exist in the form of an air bubble in the liquid.

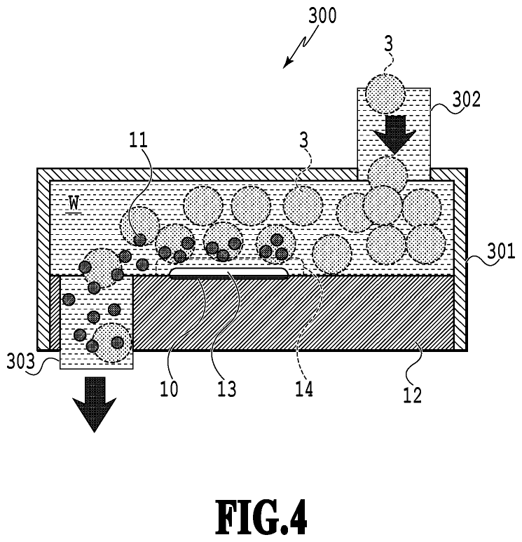

FIG. 4 is a schematic configuration diagram of the T-UFB generating unit 300. The T-UFB generating unit 300 mainly includes a chamber 301, a liquid introduction passage 302, and a liquid discharge passage 303. The flow from the liquid introduction passage 302 to the liquid discharge passage 303 through the chamber 301 is formed by a not-illustrated flow pump. Various pumps including a diaphragm pump, a gear pump, and a screw pump may be employed as the flow pump. The gas-dissolved liquid 3 of the gas G put by the dissolving unit 200 is mixed in the liquid W introduced from the liquid introduction passage 302.

An element substrate 12 provided with a heating element 10 is arranged on a bottom section of the chamber 301. With a predetermined voltage pulse applied to the heating element 10, a bubble 13 generated by the film boiling (hereinafter, referred to as a film boiling bubble 13) is generated in a region in contact with the heating element 10. Then, an ultrafine bubble (UFB) 11 containing the gas G is generated caused by expansion and shrinkage of the film boiling bubble 13. As a result, a UFB-containing liquid W containing many UFBs 11 is discharged from the liquid discharge passage 303.

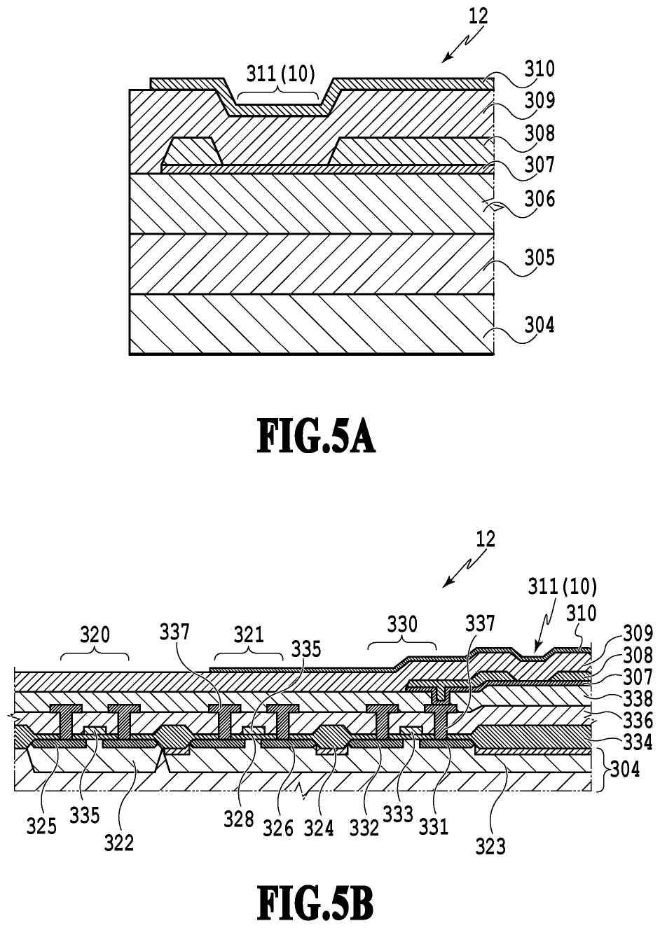

FIGS. 5A and 5B are diagrams for illustrating a detailed configuration of the heating element 10. FIG. 5A illustrates a closeup view of the heating element 10, and FIG. 5B illustrates a cross-sectional view of a wider region of the element substrate 12 including the heating element 10.

As illustrated in FIG. 5A, in the element substrate 12 of this embodiment, a thermal oxide film 305 as a heat-accumulating layer and an interlaminar film 306 also served as a heat-accumulating layer are laminated on a surface of a silicon substrate 304. An SiO₂ film or an SiN film may be used as the interlaminar film 306. A resistive layer 307 is formed on a surface of the interlaminar film 306, and a wiring 308 is partially formed on a surface of the resistive layer 307. An Al-alloy wiring of Al, Al—Si, Al—Cu, or the like may be used as the wiring 308. A protective layer 309 made of an SiO₂ film or an Si₃N₄ film is formed on surfaces of the wiring 308, the resistive layer 307, and the interlaminar film 306.

A cavitation-resistant film 310 for protecting the protective layer 309 from chemical and physical impacts due to the heat evolved by the resistive layer 307 is formed on a portion and around the portion on the surface of the protective layer 309, the portion corresponding to a heat-acting portion 311 that eventually becomes the heating element 10. A region on the surface of the resistive layer 307 in which the wiring 308 is not formed is the heat-acting portion 311 in which the resistive layer 307 evolves heat. The heating portion of the resistive layer 307 on which the wiring 308 is not formed functions as the heating element (heater) 10. As described above, the layers in the element substrate 12 are sequentially formed on the surface of the silicon substrate 304 by a semiconductor production technique, and the heat-acting portion 311 is thus provided on the silicon substrate 304.

The configuration illustrated in the drawings is an example, and various other configurations are applicable. For example, a configuration in which the laminating order of the resistive layer 307 and the wiring 308 is opposite, and a configuration in which an electrode is connected to a lower surface of the resistive layer 307 (so-called a plug electrode configuration) are applicable. In other words, as described later, any configuration may be applied as long as the configuration allows the heat-acting portion 311 to heat the liquid for generating the film boiling in the liquid.

FIG. 5B is an example of a cross-sectional view of a region including a circuit connected to the wiring 308 in the element substrate 12. An N-type well region 322 and a P-type well region 323 are partially provided in a top layer of the silicon substrate 304, which is a P-type conductor. AP-MOS 320 is formed in the N-type well region 322 and an N-MOS 321 is formed in the P-type well region 323 by introduction and diffusion of impurities by the ion implantation and the like in the general MOS process.

The P-MOS 320 includes a source region 325 and a drain region 326 formed by partial introduction of N-type or P-type impurities in a top layer of the N-type well region 322, a gate wiring 335, and so on. The gate wiring 335 is deposited on a part of a top surface of the N-type well region 322 excluding the source region 325 and the drain region 326, with a gate insulation film 328 of several hundreds of A in thickness interposed between the gate wiring 335 and the top surface of the N-type well region 322.

The N-MOS 321 includes the source region 325 and the drain region 326 formed by partial introduction of N-type or P-type impurities in a top layer of the P-type well region 323, the gate wiring 335, and so on. The gate wiring 335 is deposited on a part of a top surface of the P-type well region 323 excluding the source region 325 and the drain region 326, with the gate insulation film 328 of several hundreds of A in thickness interposed between the gate wiring 335 and the top surface of the P-type well region 323. The gate wiring 335 is made of polysilicon of 3000 Å to 5000 Å in thickness deposited by the CVD method. A C-MOS logic is constructed with the P-MOS 320 and the N-MOS 321.

In the P-type well region 323, an N-MOS transistor 330 for driving an electrothermal conversion element (heating element) is formed on a portion different from the portion including the N-MOS 321. The N-MOS transistor 330 includes a source region 332 and a drain region 331 partially provided in the top layer of the P-type well region 323 by the steps of introduction and diffusion of impurities, a gate wiring 333, and so on. The gate wiring 333 is deposited on a part of the top surface of the P-type well region 323 excluding the source region 332 and the drain region 331, with the gate insulation film 328 interposed between the gate wiring 333 and the top surface of the P-type well region 323.

In this example, the N-MOS transistor 330 is used as the transistor for driving the electrothermal conversion element. However, the transistor for driving is not limited to the N-MOS transistor 330, and any transistor may be used as long as the transistor has a capability of driving multiple electrothermal conversion elements individually and can implement the above-described fine configuration. Although the electrothermal conversion element and the transistor for driving the electrothermal conversion element are formed on the same substrate in this example, those may be formed on different substrates separately.

An oxide film separation region 324 is formed by field oxidation of 5000 Å to 10000 Å in thickness between the elements, such as between the P-MOS 320 and the N-MOS 321 and between the N-MOS 321 and the N-MOS transistor 330. The oxide film separation region 324 separates the elements. A portion of the oxide film separation region 324 corresponding to the heat-acting portion 311 functions as a heat-accumulating layer 334, which is the first layer on the silicon substrate 304.

An interlayer insulation film 336 including a PSG film, a BPSG film, or the like of about 7000 Å in thickness is formed by the CVD method on each surface of the elements such as the P-MOS 320, the N-MOS 321, and the N-MOS transistor 330. After the interlayer insulation film 336 is made flat by heat treatment, an Al electrode 337 as a first wiring layer is formed in a contact hole penetrating through the interlayer insulation film 336 and the gate insulation film 328. On surfaces of the interlayer insulation film 336 and the Al electrode 337, an interlayer insulation film 338 including an SiO₂ film of 10000 Å to 15000 Å in thickness is formed by a plasma CVD method.

On the surface of the interlayer insulation film 338, a resistive layer 307 including a TaSiN film of about 500 Å in thickness is formed by a co-sputter method on portions corresponding to the heat-acting portion 311 and the N-MOS transistor 330. The resistive layer 307 is electrically connected with the Al electrode 337 near the drain region 331 via a through-hole formed in the interlayer insulation film 338. On the surface of the resistive layer 307, the wiring 308 of Al as a second wiring layer for a wiring to each electrothermal conversion element is formed. The protective layer 309 on the surfaces of the wiring 308, the resistive layer 307, and the interlayer insulation film 338 includes an SiN film of 3000 Å in thickness formed by the plasma CVD method.

The cavitation-resistant film 310 deposited on the surface of the protective layer 309 includes a thin film of about 2000 Å in thickness, which is at least one metal selected from the group consisting of Ta, Fe, Ni, Cr, Ge, Ru, Zr, Ir, and the like. Various materials other than the above-described TaSiN such as TaN0.8, CrSiN, TaAl, WSiN, and the like can be applied as long as the material can generate the film boiling in the liquid.

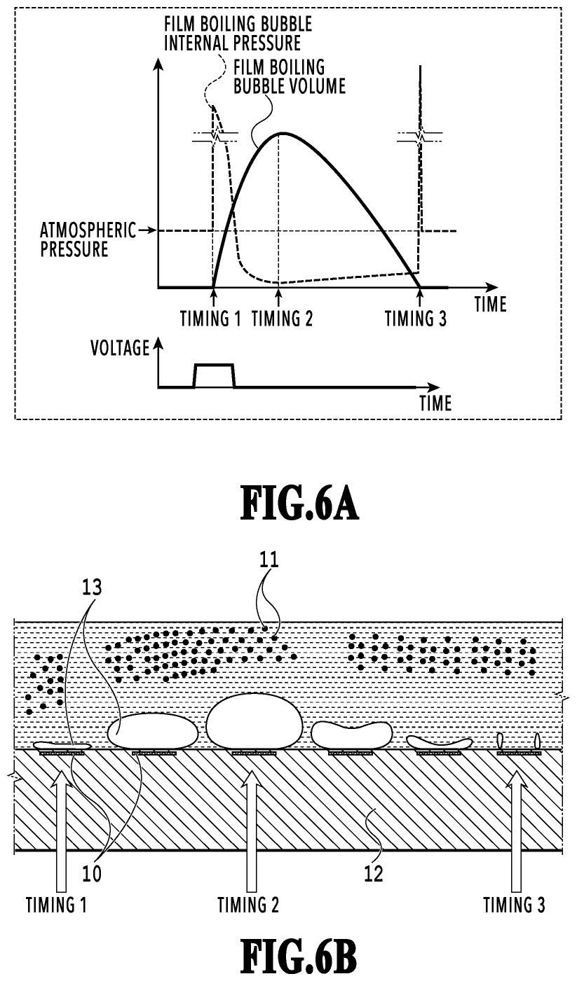

FIGS. 6A and 6B are diagrams illustrating the states of the film boiling when a predetermined voltage pulse is applied to the heating element 10. In this case, the case of generating the film boiling under atmospheric pressure is described. In FIG. 6A, the horizontal axis represents time. The vertical axis in the lower graph represents a voltage applied to the heating element 10, and the vertical axis in the upper graph represents the volume and the internal pressure of the film boiling bubble 13 generated by the film boiling. On the other hand, FIG. 6B illustrates the states of the film boiling bubble 13 in association with timings 1 to 3 shown in FIG. 6A. Each of the states is described below in chronological order.

Before a voltage is applied to the heating element 10, the atmospheric pressure is substantially maintained in the chamber 301. Once a voltage is applied to the heating element 10, the film boiling is generated in the liquid in contact with the heating element 10, and a thus-generated air bubble (hereinafter, referred to as the film boiling bubble 13) is expanded by a high pressure acting from inside (timing 1). A bubbling pressure in this process is expected to be around 8 to 10 MPa, which is a value close to a saturation vapor pressure of water.

The time for applying a voltage (pulse width) is around 0.5 μsec to 10.0 μsec, and the film boiling bubble 13 is expanded by the inertia of the pressure obtained in timing 1 even after the voltage application. However, a negative pressure generated with the expansion is gradually increased inside the film boiling bubble 13, and the negative pressure acts in a direction to shrink the film boiling bubble 13. After a while, the volume of the film boiling bubble 13 becomes the maximum in timing 2 when the inertial force and the negative pressure are balanced, and thereafter the film boiling bubble 13 shrinks rapidly by the negative pressure.

In the disappearance of the film boiling bubble 13, the film boiling bubble 13 disappears not in the entire surface of the heating element 10 but in one or more extremely small regions. For this reason, on the heating element 10, further greater force than that in the bubbling in timing 1 is generated in the extremely small region in which the film boiling bubble 13 disappears (timing 3).

The generation, expansion, shrinkage, and disappearance of the film boiling bubble 13 as described above are repeated every time a voltage pulse is applied to the heating element 10, and new UFBs 11 are generated each time.

The states of generation of the UFBs 11 in each process of the generation, expansion, shrinkage, and disappearance of the film boiling bubble 13 are further described in detail.

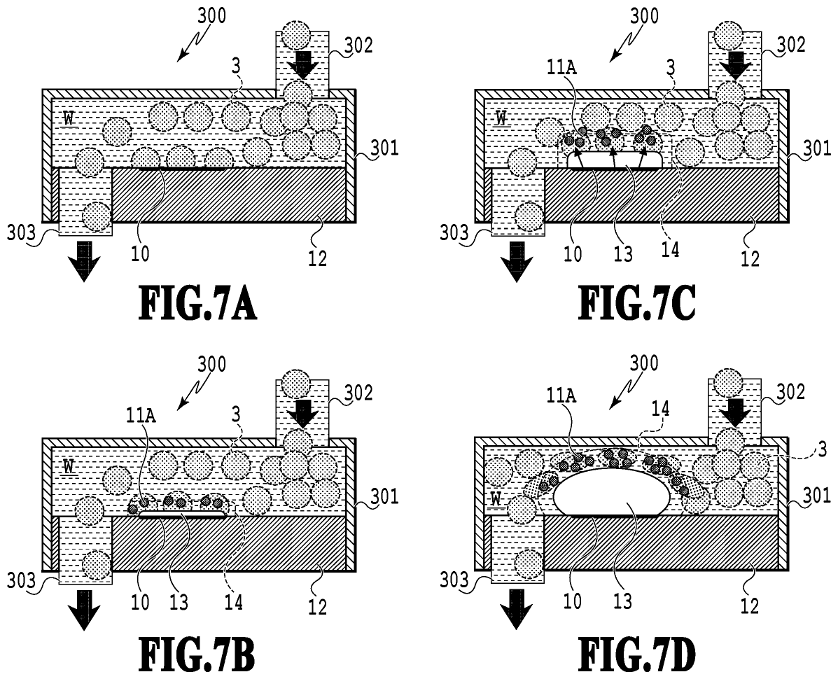

FIGS. 7A to 7D are diagrams illustrating the states of generation of the UFBs 11 caused by the generation and the expansion of the film boiling bubble 13. FIG. 7A illustrates the state before the application of a voltage pulse to the heating element 10. The liquid W in which the gas-dissolved liquids 3 are mixed flows inside the chamber 301.

FIG. 7B illustrates the state where a voltage is applied to the heating element 10, and the film boiling bubble 13 is evenly generated in almost all over the region of the heating element 10 in contact with the liquid W. When a voltage is applied, the surface temperature of the heating element 10 rapidly increases at a speed of 10° C./μsec. The film boiling occurs at a time point when the temperature reaches almost 300° C., and the film boiling bubble 13 is thus generated.

Thereafter, the surface temperature of the heating element 10 keeps increasing to around 600 to 800° C. during the pulse application, and the liquid around the film boiling bubble 13 is rapidly heated as well. In FIG. 7B, a region of the liquid that is around the film boiling bubble 13 and to be rapidly heated is indicated as a not-yet-bubbling high temperature region 14. The gas-dissolved liquid 3 within the not-yet-bubbling high temperature region 14 exceeds the thermal dissolution limit and is precipitated to become the UFB. The thus-precipitated air bubbles have diameters of around 10 nm to 100 nm and large gas-liquid interface energy. Thus, the air bubbles float independently in the liquid W without disappearing in a short time. In this embodiment, the air bubbles generated by the thermal action in the case of expanding the film boiling bubble 13 are called first UFBs 11A.

FIG. 7C illustrates the state where the film boiling bubble 13 is expanded. Even after the voltage pulse application to the heating element 10, the film boiling bubble 13 continues expansion by the inertia of the force obtained from the generation thereof, and the not-yet-bubbling high temperature region 14 is also moved and spread by the inertia. Specifically, in the process of the expansion of the film boiling bubble 13, the gas-dissolved liquid 3 within the not-yet-bubbling high temperature region 14 is precipitated as a new air bubble and becomes the first UFB 11A.

FIG. 7D illustrates the state where the film boiling bubble 13 has the maximum volume. As the film boiling bubble 13 is expanded by the inertia, the negative pressure inside the film boiling bubble 13 is gradually increased along with the expansion, and the negative pressure acts to shrink the film boiling bubble 13. At a time point when the negative pressure and the inertial force are balanced, the volume of the film boiling bubble 13 becomes the maximum, and then the shrinkage is started.

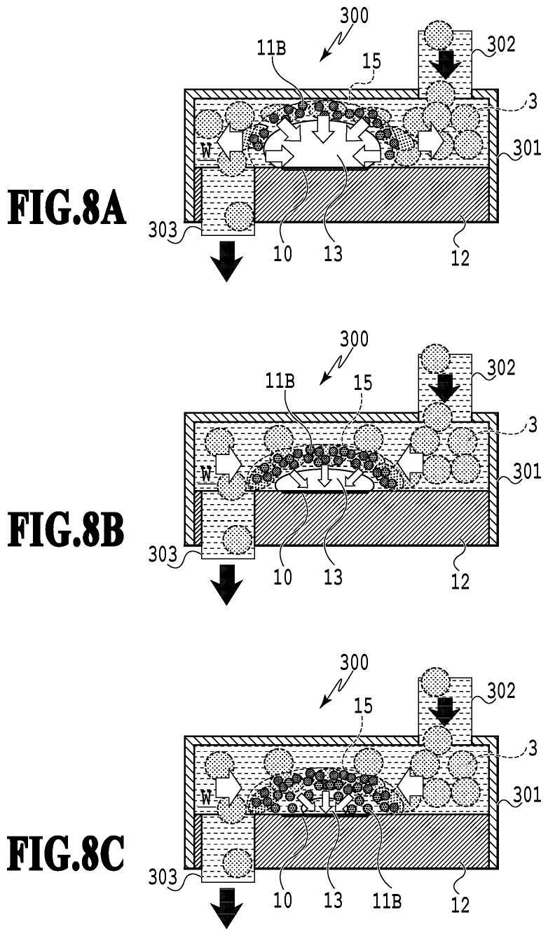

FIGS. 8A to 8C are diagrams illustrating the states of generation of the UFBs 11 caused by the shrinkage of the film boiling bubble 13. FIG. 8A illustrates the state where the film boiling bubble 13 starts shrinking. Although the film boiling bubble 13 starts shrinking, the surrounding liquid W still has the inertial force in the expansion direction. Because of this, the inertial force acting in the direction of going away from the heating element 10 and the force going toward the heating element 10 caused by the shrinkage of the film boiling bubble 13 act in a surrounding region extremely close to the film boiling bubble 13, and the region is depressurized. The region is indicated in the drawings as a not-yet-bubbling negative pressure region 15.

The gas-dissolved liquid 3 within the not-yet-bubbling negative pressure region 15 exceeds the pressure dissolution limit and is precipitated to become an air bubble. The thus-precipitated air bubbles have diameters of about 100 nm and thereafter float independently in the liquid W without disappearing in a short time. In this embodiment, the air bubbles precipitated by the pressure action during the shrinkage of the film boiling bubble 13 are called the second UFBs 11B.

FIG. 8B illustrates a process of the shrinkage of the film boiling bubble 13. The shrinking speed of the film boiling bubble 13 is accelerated by the negative pressure, and the not-yet-bubbling negative pressure region 15 is also moved along with the shrinkage of the film boiling bubble 13. Specifically, in the process of the shrinkage of the film boiling bubble 13, the gas-dissolved liquids 3 within a part over the not-yet-bubbling negative pressure region 15 are precipitated one after another and become the second UFBs 11B.

FIG. 8C illustrates the state immediately before the disappearance of the film boiling bubble 13. Although the moving speed of the surrounding liquid W is also increased by the accelerated shrinkage of the film boiling bubble 13, a pressure loss occurs due to a flow passage resistance in the chamber 301. As a result, the region occupied by the not-yet-bubbling negative pressure region 15 is further increased, and a number of the second UFBs 11B are generated.

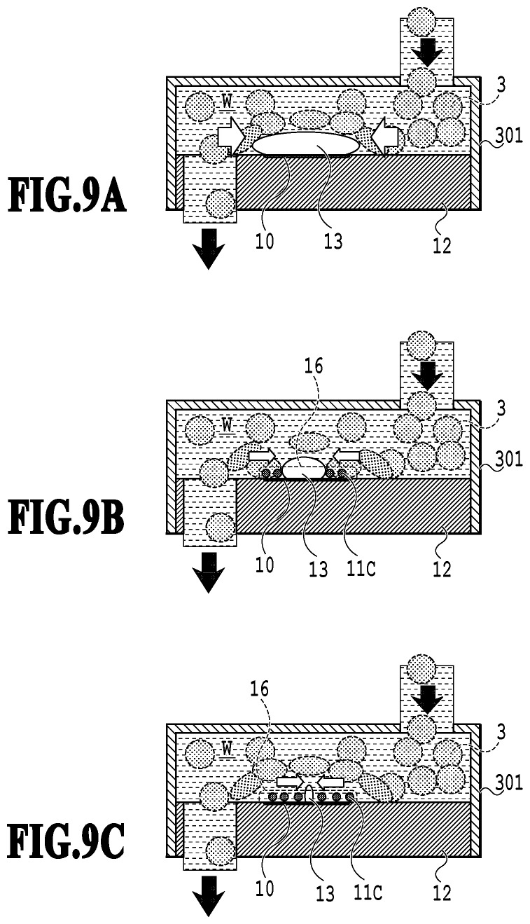

FIGS. 9A to 9C are diagrams illustrating the states of generation of the UFBs by reheating of the liquid W during the shrinkage of the film boiling bubble 13. FIG. 9A illustrates the state where the surface of the heating element 10 is covered with the shrinking film boiling bubble 13.

FIG. 9B illustrates the state where the shrinkage of the film boiling bubble 13 has progressed, and a part of the surface of the heating element 10 comes in contact with the liquid W. In this state, there is heat left on the surface of the heating element 10, but the heat is not high enough to cause the film boiling even if the liquid W comes in contact with the surface. A region of the liquid to be heated by coming in contact with the surface of the heating element 10 is indicated in the drawings as a not-yet-bubbling reheated region 16. Although the film boiling is not made, the gas-dissolved liquid 3 within the not-yet-bubbling reheated region 16 exceeds the thermal dissolution limit and is precipitated. In this embodiment, the air bubbles generated by the reheating of the liquid W during the shrinkage of the film boiling bubble 13 are called the third UFBs 11C.

FIG. 9C illustrates the state where the shrinkage of the film boiling bubble 13 has further progressed. The smaller the film boiling bubble 13, the greater the region of the heating element 10 in contact with the liquid W, and the third UFBs 11C are generated until the film boiling bubble 13 disappears.

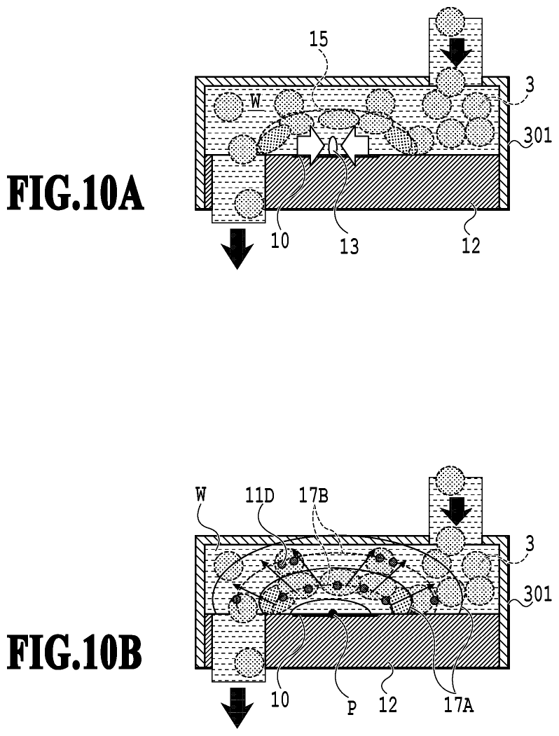

FIGS. 10A and 10B are diagrams illustrating the states of generation of the UFBs caused by an impact from the disappearance of the film boiling bubble 13 generated by the film boiling (that is, a type of cavitation). FIG. 10A illustrates the state immediately before the disappearance of the film boiling bubble 13. In this state, the film boiling bubble 13 shrinks rapidly by the internal negative pressure, and the not-yet-bubbling negative pressure region 15 surrounds the film boiling bubble 13.

FIG. 10B illustrates the state immediately after the film boiling bubble 13 disappears at a point P. When the film boiling bubble 13 disappears, acoustic waves ripple concentrically from the point P as a starting point due to the impact of the disappearance. The acoustic wave is a collective term of an elastic wave that is propagated through anything regardless of gas, liquid, and solid. In this embodiment, compression waves of the liquid W, which are a high pressure surface 17A and a low pressure surface 17B of the liquid W, are propagated alternately.

In this case, the gas-dissolved liquid 3 within the not-yet-bubbling negative pressure region 15 is resonated by the shock waves made by the disappearance of the film boiling bubble 13, and the gas-dissolved liquid 3 exceeds the pressure dissolution limit and the phase transition is made in timing when the low pressure surface 17B passes therethrough. Specifically, a number of air bubbles are precipitated in the not-yet-bubbling negative pressure region 15 simultaneously with the disappearance of the film boiling bubble 13. In this embodiment, the air bubbles generated by the shock waves made by the disappearance of the film boiling bubble 13 are called fourth UFBs 11D.

The fourth UFBs 11D generated by the shock waves made by the disappearance of the film boiling bubble 13 suddenly appear in an extremely short time (1 μS or less) in an extremely narrow thin film-shaped region. The diameter is sufficiently smaller than that of the first to third UFBs, and the gas-liquid interface energy is higher than that of the first to third UFBs. For this reason, it is considered that the fourth UFBs 11D have different characteristics from the first to third UFBs 11A to 11C and generate different effects.

Additionally, the fourth UFBs 11D are evenly generated in many parts of the region of the concentric sphere in which the shock waves are propagated, and the fourth UFBs 11D evenly exist in the chamber 301 from the generation thereof. Although many first to third UFBs already exist in the timing of the generation of the fourth UFBs 11D, the presence of the first to third UFBs does not affect the generation of the fourth UFBs 11D greatly. The first to third UFBs do not disappear due to the generation of the fourth UFBs 11D.

As described above, the UFBs 11 are generated in the multiple stages from the generation to the disappearance of the film boiling bubble 13 by the heat generation of the heating element 10. Although the above example illustrates the stages to the disappearance of the film boiling bubble 13, the way of generating the UFBs is not limited thereto. For example, with the generated film boiling bubble 13 communicating with the atmospheric air before the bubble disappearance, the UFBs can be generated also if the film boiling bubble 13 does not reach the disappearance.

Next, remaining properties of the UFBs are described. The higher the temperature of the liquid, the lower the dissolution properties of the gas components, and the lower the temperature, the higher the dissolution properties of the gas components. In other words, the phase transition of the dissolved gas components is prompted and the generation of the UFBs becomes easier as the temperature of the liquid is higher. The temperature of the liquid and the solubility of the gas are in the inverse relationship, and the gas exceeding the saturation solubility is transformed into air bubbles and precipitated into the liquid as the liquid temperature increases.

Therefore, when the temperature of the liquid rapidly increases from normal temperature, the dissolution properties are decreased without stopping, and the generation of the UFBs starts. The thermal dissolution properties are decreased as the temperature increases, and a number of the UFBs are generated.

Conversely, when the temperature of the liquid decreases from normal temperature, the dissolution properties of the gas are increased, and the generated UFBs are more likely to be liquefied. However, the temperature is sufficiently lower than normal temperature. Additionally, since the once generated UFBs have a high internal pressure and large gas-liquid interface energy even when the temperature of the liquid decreases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the first UFBs 11A described with FIGS. 7A to 7C and the third UFBs 11C described with FIGS. 9A to 9C can be described as UFBs that are generated by utilizing such thermal dissolution properties of gas.

On the other hand, in the relationship between the pressure and the dissolution properties of liquid, the higher the pressure of the liquid, the higher the dissolution properties of the gas, and the lower the pressure, the lower the dissolution properties. In other words, the phase transition to the gas of the gas-dissolved liquid dissolved in the liquid is prompted and the generation of the UFBs becomes easier as the pressure of the liquid is lower. Once the pressure of the liquid becomes lower than normal pressure, the dissolution properties are decreased without stopping, and the generation of the UFBs starts. The pressure dissolution properties are decreased as the pressure decreases, and a number of the UFBs are generated.

Conversely, when the pressure of the liquid increases to be higher than normal temperature, the dissolution properties of the gas are increased, and the generated UFBs are more likely to be liquefied. However, the pressure is sufficiently higher than the atmospheric pressure. Additionally, since the once generated UFBs have a high internal pressure and large gas-liquid interface energy even when the pressure of the liquid increases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the second UFBs 11B described with FIGS. 8A to 8C and the fourth UFBs 11D described with FIGS. 10A to 10B can be described as UFBs that are generated by utilizing such pressure dissolution properties of gas.

Those first to fourth UFBs generated by different causes are described individually above; however, the above-described generation causes occur simultaneously with the event of the film boiling. Thus, at least two types of the first to the fourth UFBs may be generated at the same time, and these generation causes may cooperate to generate the UFBs. It should be noted that it is common for all the generation causes to be induced by the film boiling phenomenon. Hereinafter, in this specification, the method of generating the UFBs by utilizing the film boiling caused by the rapid heating as described above is referred to as a thermal-ultrafine bubble (T-UFB) generating method. Additionally, the UFBs generated by the T-UFB generating method are referred to as T-UFBs, and the liquid containing the T-UFBs generated by the T-UFB generating method is referred to as a T-UFB-containing liquid.

Almost all the air bubbles generated by the T-UFB generating method are 1.0 μm or less, and milli-bubbles and microbubbles are unlikely to be generated. That is, the T-UFB generating method allows efficient generation of the only UFBs. Additionally, the T-UFBs generated by the T-UFB generating method have larger gas-liquid interface energy than that of the UFBs generated by a conventional method, and the T-UFBs do not disappear easily as long as being stored at normal temperature and normal pressure. Moreover, even if new T-UFBs are generated by new film boiling, the already generated T-UFBs never disappear due to the impact from the new generation. That is, it can be said that the number and the concentration of the T-UFBs contained in the T-UFB-containing liquid have the hysteresis properties depending on the number of times the film boiling is made in the T-UFB-containing liquid. In other words, it is possible to adjust the concentration of the T-UFBs contained in the T-UFB-containing liquid by controlling the number of the heating elements provided in the T-UFB generating unit 300 and the number of the voltage pulse application to the heating elements.

Reference to FIG. 1 is made again. Once the T-UFB-containing liquid W with a desired UFB concentration is generated in the T-UFB generating unit 300, the UFB-containing liquid W is supplied to the post-processing unit 400.

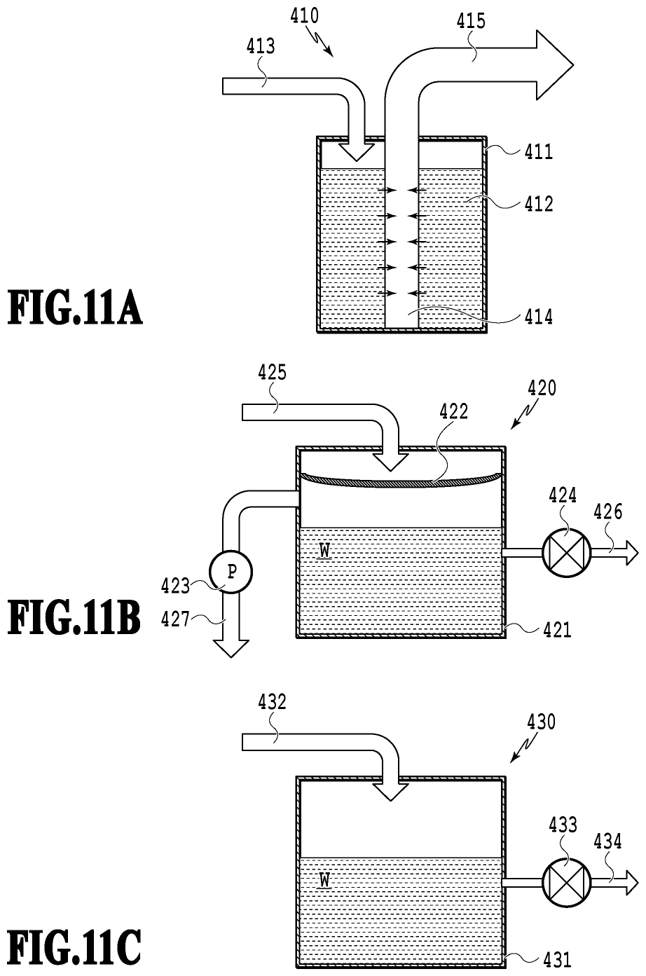

FIGS. 11A to 11C are diagrams illustrating configuration examples of the post-processing unit 400 of this embodiment. The post-processing unit 400 of this embodiment removes impurities in the UFB-containing liquid W in stages in the order from inorganic ions, organic substances, and insoluble solid substances.

FIG. 11A illustrates a first post-processing mechanism 410 that removes the inorganic ions. The first post-processing mechanism 410 includes an exchange container 411, cation exchange resins 412, a liquid introduction passage 413, a collecting pipe 414, and a liquid discharge passage 415. The exchange container 411 stores the cation exchange resins 412. The UFB-containing liquid W generated by the T-UFB generating unit 300 is injected to the exchange container 411 through the liquid introduction passage 413 and absorbed into the cation exchange resins 412 such that the cations as the impurities are removed. Such impurities include metal materials peeled off from the element substrate 12 of the T-UFB generating unit 300, such as SiO₂, SiN, SiC, Ta, Al₂O₃, Ta₂O₅, and Ir.

The cation exchange resins 412 are synthetic resins in which a functional group (ion exchange group) is introduced in a high polymer matrix having a three-dimensional network, and the appearance of the synthetic resins are spherical particles of around 0.4 to 0.7 mm. A general high polymer matrix is the styrene-divinylbenzene copolymer, and the functional group may be that of methacrylic acid series and acrylic acid series, for example. However, the above material is an example. As long as the material can remove desired inorganic ions effectively, the above material can be changed to various materials. The UFB-containing liquid W absorbed in the cation exchange resins 412 to remove the inorganic ions is collected by the collecting pipe 414 and transferred to the next step through the liquid discharge passage 415.

FIG. 11B illustrates a second post-processing mechanism 420 that removes the organic substances. The second post-processing mechanism 420 includes a storage container 421, a filtration filter 422, a vacuum pump 423, a valve 424, a liquid introduction passage 425, a liquid discharge passage 426, and an air suction passage 427. Inside of the storage container 421 is divided into upper and lower two regions by the filtration filter 422. The liquid introduction passage 425 is connected to the upper region of the upper and lower two regions, and the air suction passage 427 and the liquid discharge passage 426 are connected to the lower region thereof. Once the vacuum pump 423 is driven with the valve 424 closed, the air in the storage container 421 is discharged through the air suction passage 427 to make the pressure inside the storage container 421 negative pressure, and the UFB-containing liquid W is thereafter introduced from the liquid introduction passage 425. Then, the UFB-containing liquid W from which the impurities are removed by the filtration filter 422 is retained into the storage container 421.

The impurities removed by the filtration filter 422 include organic materials that may be mixed at a tube or each unit, such as organic compounds including silicon, siloxane, and epoxy, for example. A filter film usable for the filtration filter 422 includes a filter of a sub-μm-mesh that can remove bacteria, and a filter of a nm-mesh that can remove virus.

After a certain amount of the UFB-containing liquid W is retained in the storage container 421, the vacuum pump 423 is stopped and the valve 424 is opened to transfer the T-UFB-containing liquid in the storage container 421 to the next step through the liquid discharge passage 426. Although the vacuum filtration method is employed as the method of removing the organic impurities herein, a gravity filtration method and a pressurized filtration can also be employed as the filtration method using a filter, for example.

FIG. 11C illustrates a third post-processing mechanism 430 that removes the insoluble solid substances. The third post-processing mechanism 430 includes a precipitation container 431, a liquid introduction passage 432, a valve 433, and a liquid discharge passage 434.

First, a predetermined amount of the UFB-containing liquid W is retained into the precipitation container 431 through the liquid introduction passage 432 with the valve 433 closed, and leaving it for a while. Meanwhile, the solid substances in the UFB-containing liquid W are precipitated onto the bottom of the precipitation container 431 by gravity. Among the bubbles in the UFB-containing liquid, relatively large bubbles such as microbubbles are raised to the liquid surface by the buoyancy and also removed from the UFB-containing liquid. After a lapse of sufficient time, the valve 433 is opened, and the UFB-containing liquid W from which the solid substances and large bubbles are removed is transferred to the collecting unit 500 through the liquid discharge passage 434.

Reference to FIG. 1 is made again. The T-UFB-containing liquid W from which the impurities are removed by the post-processing unit 400 may be directly transferred to the collecting unit 500 or may be put back to the dissolving unit 200 again. In the latter case, the gas dissolution concentration of the T-UFB-containing liquid W that is decreased due to the generation of the T-UFBs can be compensated to the saturated state again by the dissolving unit 200. If new T-UFBs are generated by the T-UFB generating unit 300 after the compensation, it is possible to further increase the concentration of the UFBs contained in the T-UFB-containing liquid with the above-described properties. That is, it is possible to increase the concentration of the contained UFBs by the number of circulations through the dissolving unit 200, the T-UFB generating unit 300, and the post-processing unit 400, and it is possible to transfer the UFB-containing liquid W to the collecting unit 500 after a predetermined concentration of the contained UFBs is obtained.

Here, an effect of putting back the generated T-UFB-containing liquid W to the dissolving unit 200 again is simply described in accordance with details of specific testing performed by the present inventors. First, in the T-UFB generating unit 300, 10000 pieces of the heating elements 10 were arranged on the element substrate 12. Industrial pure water was used as the liquid W and was flowed in the chamber 301 of the T-UFB generating unit 300 at a flow rate of 1.0 liter/hour. I this state, a voltage pulse with a voltage of 24 V and a pulse width of 1.0 μs was applied at a driving frequency of 10 KHz to the individual heating elements.

In a case where the generated T-UFB-containing liquid W was collected by the collecting unit 500 without putting back to the dissolving unit 200, that is, in a case where the number of circulation was one time, 3.6 billion pieces per mL of the UFBs were confirmed in the T-UFB-containing liquid W collected by the collecting unit 500. On the other hand, in a case where the operation of putting back the T-UFB-containing liquid W to the dissolving unit 200 was performed nine times, that is, in a case where the number of circulation was ten times, 36 billion pieces per mL of the UFBs were confirmed in the T-UFB-containing liquid W collected by the collecting unit 500. That is, it was confirmed that the UFB-containing concentration is increased in the proportion of the number of circulation. The number density of the UFBs as described above was obtained by counting the UFBs smaller than 1.0 μm in diameter contained in the UFB-containing liquid W of a predetermined volume by using a measuring instrument (model number SALD-7500) manufactured by SHIMADZU CORPORATION.

The collecting unit 500 collects and preserves the UFB-containing liquid W transferred from the post-processing unit 400. The T-UFB-containing liquid collected by the collecting unit 500 is a UFB-containing liquid with high purity from which various impurities are removed.

In the collecting unit 500, the UFB-containing liquid W may be classified by the size of the T-UFBs by performing some stages of filtration processing. Since it is expected that the temperature of the T-UFB-containing liquid W obtained by the T-UFB generating method is higher than normal temperature, the collecting unit 500 may be provided with a cooling unit. The cooling unit may be provided to a part of the post-processing unit 400.

The schematic description of the UFB generating apparatus 1 is given above; however, it is needless to say that the illustrated multiple units can be changed, and not all of them need to be prepared. Depending on the type of the liquid W and the gas G to be used and the intended use of the T-UFB-containing liquid to be generated, a part of the above-described units may be omitted, or another unit other than the above-described units may be added.

For example, when the gas to be contained by the UFBs is the atmospheric air, the degassing unit 100 and the dissolving unit 200 can be omitted. On the other hand, when multiple kinds of gases are desired to be contained by the UFBs, another dissolving unit 200 may be added.

The functions of some units illustrated in FIG. 1 can be integrated into a single unit. For example, the dissolving unit 200 and the T-UFB generating unit 300 can be integrated by arranging the heating element 10 in the dissolving container 201 illustrated in FIGS. 3A and 3B. Specifically, an electrode type T-UFB module is disposed in a gas dissolving container (high-pressure chamber), and multiple heaters arranged in the module are driven to make film boiling. Such a configuration allows a single unit to generate T-UFBs containing a gas while dissolving the gas therein. In this case, with the T-UFB module arranged on a base of the gas dissolving container, a Marangoni flow occurs due to the heat generated by the heaters, and the liquid in the container can be agitated to some extent without providing a circulating and agitating unit.

The removing units for removing the impurities as illustrated in FIGS. 11A to 11C may be provided upstream of the T-UFB generating unit 300 as a part of the pre-processing unit or may be provided both upstream and downstream thereof. In a case where the liquid to be supplied to the UFB generating apparatus is tap water, rain water, contaminated water, or the like, there may be included organic and inorganic impurities in the liquid. If such a liquid W including the impurities is supplied to the T-UFB generating unit 300, there occurs a risk of deteriorating the heating element 10 and inducing the salting-out phenomenon. With the mechanisms as illustrated in FIGS. 11A to 11C provided upstream of the T-UFB generating unit 300, it is possible to remove the above-described impurities previously and to more efficiently generate a UFB-containing liquid with higher purity.

Particularly, in a case where an impurity removing unit using an ion-exchange resin illustrated in FIG. 11A is provided in the pre-processing unit, arrangement an anion-exchange resin contributes efficient generation of T-UFB water. This is because it has been confirmed that the ultra-fine bubbles generated by the T-UFB generating unit 300 have a negative charge. Accordingly, T-UFB water with high purity can be generated by removing the impurities having the same negative charges in the pre-processing unit. As the anion-exchange resin used herein, both the strongly basic anion-exchange resin having quaternary ammonium group and weakly basic anion-exchange resin having primary to tertiary amine group are appropriate. Which of these is appropriate depends on the type of the liquid to be used. Usually, in a case of using tap water, pure water, or the like as the liquid, the function of removing the impurities can be fulfilled sufficiently by using only the latter weakly basic anion-exchange resin.

### <<Liquid and Gas Usable for T-UFB-Containing Liquid>>

Now, the liquid W usable for generating the T-UFB-containing liquid is described. The liquid W usable in this embodiment is, for example, pure water, ion exchange water, distilled water, bioactive water, magnetic active water, lotion, tap water, sea water, river water, clean and sewage water, lake water, underground water, rain water, and so on. A mixed liquid containing the above liquid and the like is also usable. A mixed solvent containing water and soluble organic solvent can be also used. The soluble organic solvent to be used by being mixed with water is not particularly limited; however, the followings can be a specific example thereof. An alkyl alcohol group of the carbon number of 1 to 4 including methyl alcohol, ethyl alcohol, n-propyl alcohol, isopropyl alcohol, n-butyl alcohol, sec-butyl alcohol, and tert-butyl alcohol. An amide group including N-methyl-2-pyrrolidone, 2-pyrrolidone, 1,3-dimethyl-2-imidazolidinone, N,N-dimethylformamide, and N,N-dimethylacetamide. A keton group or a ketoalcohol group including acetone and diacetone alcohol. A cyclic ether group including tetrahydrofuran and dioxane. A glycol group including ethylene glycol, 1,2-propylene glycol, 1,3-propylene glycol, 1,2-butanediol, 1,3-butanediol, 1,4-butanediol, 1,5-pentanediol, 1,2-hexanediol, 1,6-hexanediol, 3-methyl-1,5-pentanediol, diethylene glycol, triethylene glycol, and thiodiglycol. A group of lower alkyl ether of polyhydric alcohol including ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, and triethylene glycol monobutyl ether. A polyalkylene glycol group including polyethylene glycol and polypropylene glycol. A triol group including glycerin, 1,2,6-hexanetriol, and trimethylolpropane. These soluble organic solvents can be used individually, or two or more of them can be used together. Specifically, the soluble organic solvents can be used various liquid capable of generating the film boiling.

A gas component that can be introduced into the dissolving unit 200 is, for example, hydrogen, helium, oxygen, nitrogen, methane, fluorine, neon, carbon dioxide, ozone, argon, chlorine, ethane, propane, air, and so on. The gas component may be a mixed gas containing some of the above. Additionally, it is not necessary for the dissolving unit 200 to dissolve a substance in a gas state, and the dissolving unit 200 may fuse a liquid or a solid containing desired components into the liquid W. The dissolution in this case may be spontaneous dissolution, dissolution caused by pressure application, or dissolution caused by hydration, ionization, and chemical reaction due to electrolytic dissociation.

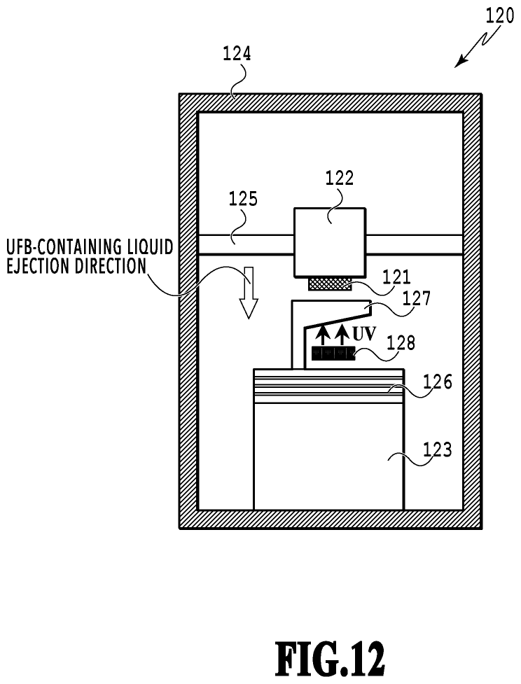

FIG. 12 is a schematic configuration diagram illustrating a UFB generating apparatus 120 in the present embodiment. The UFB generating apparatus 120 includes a UFB generating unit (ultra-fine bubble generate unit) 121 that generates the UFBs, a liquid supplying unit 122, and a collecting container 123, and those are stored in a housing 124 as an exterior. The liquid supplying unit 122 is fixed to a guide 125, and a liquid in which a gas component is dissolved that is stored in the liquid supplying unit 122 is supplied to the UFB generating unit 121 through a not-illustrated liquid-passing pipe. The UFB generating unit 121 of the UFB generating apparatus 120 corresponds to the T-UFB generating unit 300 in FIG. 1. The collecting container 123 corresponds to the post-processing unit 400 or the collecting unit 500 in FIG. 1.

The UFB generating unit 121 includes multiple ejecting ports to eject the liquid. The UFB generating unit 121 supplied with the liquid generates the UFBs by making film boiling in the liquid by an action of the later-described heat energy generating element and ejects the liquid (droplet) containing the UFBs from the multiple ejecting ports. The ejected liquid containing the UFBs reaches a liquid-receiving surface by way of an opening of a receiving jig 127 and is collected by the collecting container 123.

The collecting container 123 is a cylindrical glass container of 2 cm in diameter and 2 cm in height, and a spiral groove 126 for screwing a cap therein is formed in a portion of about 5 mm on a top portion of the collecting container 123. With this, after a predetermined amount of the UFB-containing liquid is retained in the collecting container 123, the collecting container 123 can be taken out from the UFB generating apparatus 120 and closed by a not-illustrated cap, and thus the collecting container 123 can be carried while keeping the inside sealed.

In order to efficiently collect the UFB-containing liquid, the liquid-receiving surface of the receiving jig 127 is provided over a wider range than an ejecting port surface in which the ejecting ports of the UFB generating unit 121 are aligned, and the distance from the ejecting port surface is preferably as short as possible. To be specific, the distance from the ejecting port surface to the opening of the receiving jig 127 is preferably 50 mm or less. In the present embodiment, the distance from the ejecting port surface to the opening surface of the receiving jig 127 is 5 mm.

In the present embodiment, a mode in which a cap is screwed to close the collecting container 123 is described as an example; however, the mode for sealing the collecting container 123 is not limited thereto. For example, various modes can be employed such as a mode in which an elastic cap is pushed into a collecting port of the collecting container 123, a mode in which the collecting port of the collecting container 123 is thermally sealed, and additionally a mode in which the collecting port is closed by using a zipper.

In the UFB generating apparatus 120 of the present embodiment, here is provided an ultraviolet ray radiating mechanism (hereinafter, also referred to as an UV radiating mechanism) 128 facing the ejecting port surface of the UFB generating unit 121.

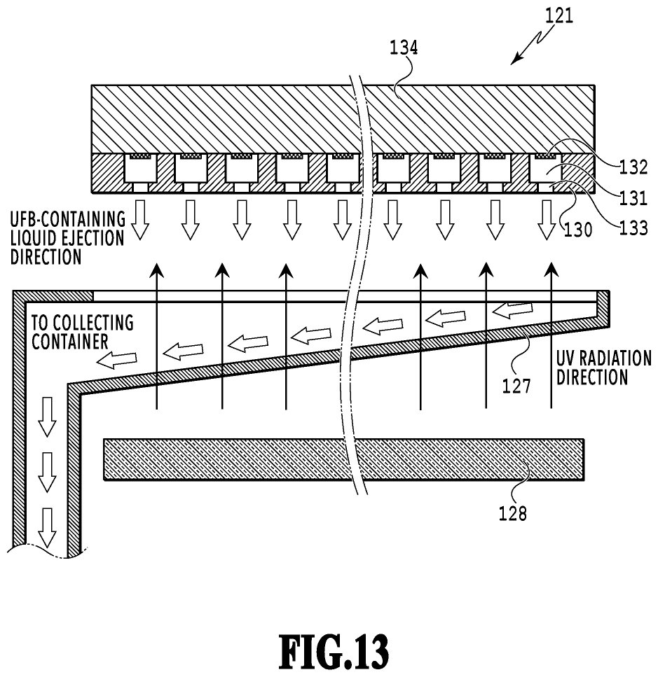

FIG. 13 is a diagram illustrating the UFB generating unit 121 irradiated with ultraviolet rays by the UV radiating mechanism 128. The UV radiating mechanism 128 is capable of radiating ultraviolet rays and irradiating the UFB generating unit 121 with the ultraviolet rays. The receiving jig 127 is formed to allow the ultraviolet rays to pass therethrough and is, for example, formed of a transparent member. The ultraviolet rays radiated from the UV radiating mechanism 128 passes through the receiving jig 127 and irradiates the UFB generating unit 121. A covering member 130 provided on the UFB generating unit 121 is also formed to allow the ultraviolet rays to pass therethrough and is, for example, formed of a transparent member. The ultraviolet rays radiated from the UV radiating mechanism 128 irradiates the liquid in a bubbling chamber 131. With the ultraviolet rays radiated from the UV radiating mechanism 128 onto the UFB generating unit 121, viable cells that invade the UFB generating unit 121 can be sterilized.

If viable cells invade the UFB generating unit 121, the viable cells are attached to a heat energy generating element (heating unit) 132 and proliferate, and thus a viable cell colony is formed. If a voltage is applied to the heat energy generating element 132 in a state where a viable cell colony is formed, there is a risk of damage in the heat energy generating element 132 due to heating abnormality. In a case where a viable cell colony is formed in the bubbling chamber 131, there is a risk of having bad effects on the air bubble generation that is the basis for the UFB generation. In order to suppress those problems, the ultraviolet ray radiation is performed on the liquid in the bubbling chamber 131 by using the UV radiating mechanism 128, and thus the viable cells that invade the UFB generating unit 121 are sterilized.

It is said that the absorption spectrum of light of deoxyribonucleic acid (DNA) that bacteria have is the highest in the absorption coefficient around 260 nm. For this reason, a wavelength region of the ultraviolet rays used for the ultraviolet ray radiation sterilization is preferably within a range from 240 nm to 280 nm, and the most preferable wavelength of the ultraviolet rays is 260 nm. In the present embodiment, a UV lamp that emits ultraviolet rays of 254 nm in wavelength is used. The ultraviolet ray radiation is preferably performed constantly.

In the present embodiment, the UV radiating mechanism 128 is provided at a position facing the UFB generating unit 121; however, as long as it is possible to perform the ultraviolet ray radiation on the wetted portion inside the UFB generating unit 121, the position may not face the UFB generating unit 121. For example, a configuration in which the ultraviolet rays are reflected by a mirror to irradiate the wetted portion of the UFB generating unit 121 may be applied.

The liquid containing the UFBs that is ejected from an ejecting port 133 of the UFB generating unit 121 is received by the inclined liquid-receiving surface of the receiving jig 127, flows along the inclined liquid-receiving surface, and is collected by the collecting container 123.

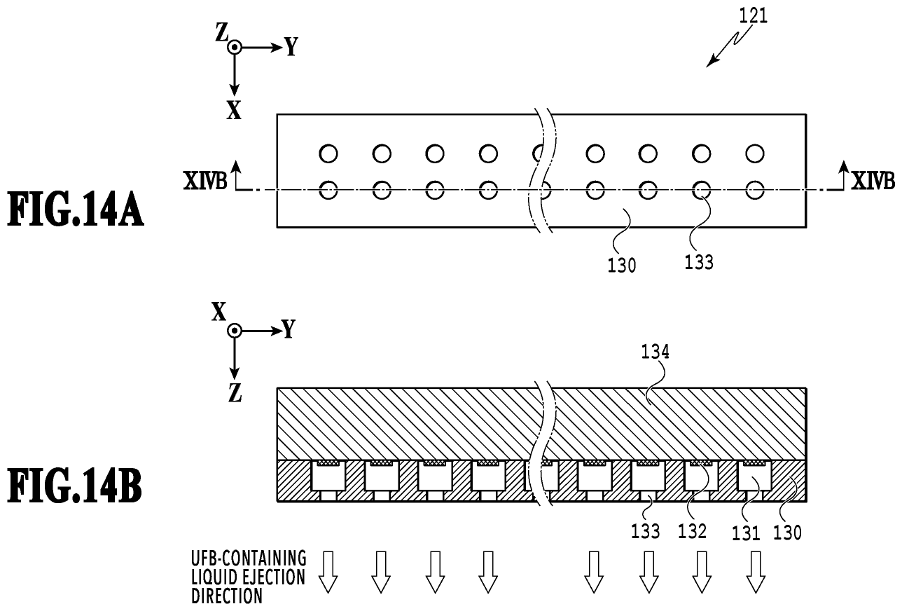

FIGS. 14A and 14B are diagrams illustrating the UFB generating unit 121, and FIG. 14A is a bottom view from an ejecting port surface side while FIG. 14B is a cross-sectional view taken along XIVB-XIVB in FIG. 14A. In the UFB generating unit 121, the heat energy generating element 132 (corresponding to the heating element 10 in FIG. 4) and the covering member 130 are formed on a heating element substrate 134, and in the covering member 130, the ejecting port 133 to eject the liquid and the bubbling chamber 131 are provided. The ejecting port 133 and the bubbling chamber 131 communicate with each other. In an arrow Y direction, 768 pieces of the ejecting ports 133 are aligned at a density of 1200 dpi (dot/inch). The configuration of the ejecting ports is not limited thereto, and the alignment density, alignment pattern, and ejection port diameter of the ejecting ports may be changed taking into account the generating capacity of the UFB-containing liquid.

With a voltage applied to the heating element substrate 134, the voltage is applied to the heat energy generating element 132, and the heat energy generating element 132 is heated immediately. With the heat energy generating element 132 heated, film boiling is made in the liquid inside the bubbling chamber 131 being in contact with the heat energy generating element 132, and an air bubble (not illustrated) is generated. The air bubble grows along with a rise in the surface temperature of the heat energy generating element 132; however, since a negative pressure inside is also increased with the volume, the growth is stopped at a certain level. If the application of the voltage to the heat energy generating element 132 is stopped before the air bubble reaches the maximum volume, the temperature of the heat energy generating element 132 is decreased, the air bubble starts shrinking, and once the liquid is put in contact with the surface of the heat energy generating element 132 again, the air bubble disappears.

During the disappearance of the air bubble, there occur first cavitation, which occurs because the shrinking air bubble is put in contact with the heat energy generating element 132, and second cavitation, which occurs because a small bubble (not illustrated) remaining after the first cavitation disappears like a spark. With the driving of the heat energy generating element 132 that causes cavitation as described above, ultra-fine bubbles (UFBs) that are air bubbles smaller than 1 μm in size are generated in a liquid. It is presumed that many UFBs are generated from a gas component dissolved in the liquid by the film boiling made in the liquid by heating the heat energy generating element 132. With generation, growth, shrinkage, and disappearance of the air bubble performed by using the film boiling as described above, a highly pure UFB-containing liquid can be manufactured in a short time with a relatively simple configuration.

In the present embodiment, the liquid supplied from the liquid supplying unit 122 is ejected as a droplet containing the UFBs from the individual ejecting ports 133 in an arrow Z direction by the growing energy of the bubble generated by making the film boiling inside the bubbling chamber 131 in the UFB generating unit 121. The ejected droplet is subjected to sterilization processing by the UV radiating mechanism 128 and is collected by the collecting container 123 arranged below the UFB generating unit 121 by way of the receiving jig 127.

Thus, the ultraviolet ray radiation is performed on the wetted portion inside the UFB generating unit 121. With this, an ultra-fine bubble-containing liquid manufacturing apparatus that can suppress the viable cell contamination inside the UFB generating unit can be provided.

Here is described an example where the ejecting port 133 is provided correspondingly to the bubbling chamber 131; however, the configuration is not limited thereto. There may be provided the bubbling chamber 131 for which no ejecting port 133 is provided. That is, a first bubbling chamber (not illustrated) that includes the heat energy generating element 132 but is not provided with the ejecting port 133, and a second bubbling chamber (bubbling chamber 131) that includes the heat energy generating element 132 and is provided with the ejecting port 133 may be arranged in the UFB generating unit 121.

### Second Embodiment

A second embodiment of the present invention is described below with reference to the drawings. Since the basic configuration of the present embodiment is similar to that of the first embodiment, a characteristic configuration is described below.

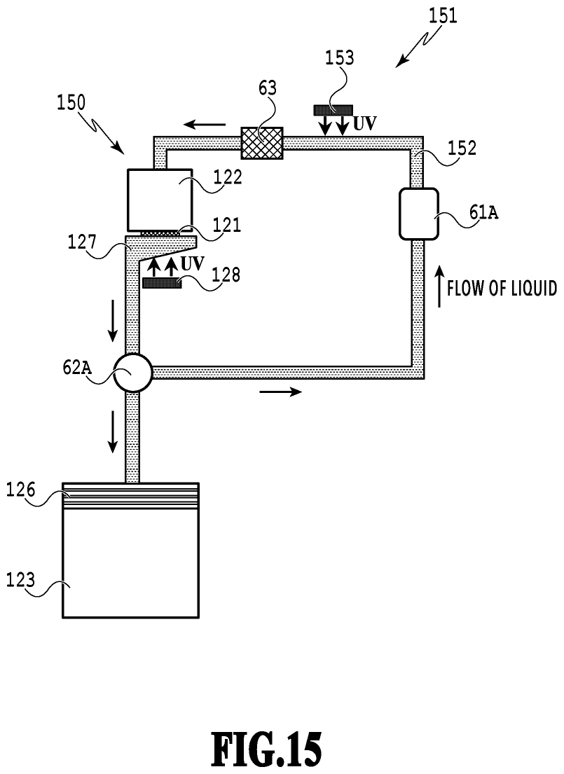

FIG. 15 is a schematic configuration diagram illustrating a UFB generating apparatus 150 in the present embodiment. The UFB generating apparatus 150 includes the UFB generating unit 121 that generates the UFBs, the liquid supplying unit 122, the collecting container 123, and a circulating system 151 that circulates the liquid. The circulating system 151 includes a circulating route 152 that connects the receiving jig 127 with the liquid supplying unit 122 and a pump 61A, a valve 62A, and a filter 63 provided in the circulating route 152. The UFB generating unit 121 of the UFB generating apparatus 150 corresponds to the T-UFB generating unit 300 in FIG. 1. The collecting container 123 corresponds to the post-processing unit 400 or the collecting unit 500 in FIG. 1.

A route extending from the receiving jig 127 is branched into two from a portion connected with a valve 62A, and one is configured to flow the liquid to the collecting container 123 while the other is configured to flow the liquid to the liquid supplying unit 122 by a switching operation by the valve 62A. In the middle of the circulating route 152 connecting the receiving jig 127 and the liquid supplying unit 122, there are provided the pump 61A that transfers the liquid from the receiving jig 127 to the liquid supplying unit 122 and a UV radiating mechanism 153 that sterilizes the liquid flowing inside the circulating route 152 by the ultraviolet ray radiation.

In the present embodiment, comparing with the first embodiment, many additional parts such as the circulating route 152, the pump 61A, the valve 62A, and the filter 63 are arranged; for this reason, once the circulating of the liquid is stopped, liquid accumulation occurs in many portions. In the liquid accumulation, a viable cell colony is likely to occur; for this reason, it is desired for the liquid itself that flows inside the additional parts such as the circulating route 152, the pump 61A, the valve 62A, and the filter 63 to be kept in a state as sterilized as possible. To this end, the UV radiating mechanism 153 is provided in the circulating system 151 to put the liquid itself in a sterilized state. In order to irradiate the liquid flowing through the circulating route 152 with the ultraviolet rays from the UV radiating mechanism 153, the circulating route 152 in a portion irradiated with the ultraviolet rays is formed of a member that allows the ultraviolet rays to pass therethrough (for example, transparent member). A place to dispose the UV radiating mechanism 153 is desirably set on an upstream side of the UFB generating unit 121 in the circulating route 152 in order to prevent viable cells from invading inside the UFB generating unit 121 as much as possible.

The ultraviolet rays radiated by the UV radiating mechanism 153 preferably has a wavelength of 240 nm to 280 nm, and in the present embodiment, as with the first embodiment, a UV lamp that emits ultraviolet rays of 254 nm in wavelength is used. The ultraviolet ray radiation by the UV radiating mechanism 153 is preferably performed constantly. The filter 63 for removing killed bacteria that are sterilized by the ultraviolet ray radiation is disposed between the UV radiating mechanism 153 and the liquid supplying unit 122. With the filter 63 disposed, it is possible to generate a UFB-containing liquid containing less impurities such as killed bacteria. The inside of the filter 63 is formed by using as a main material a non-woven fabric made of polypropylene that has excellent chemical resistance, and in the present embodiment, taking into account the size of the killed bacteria, a filter with the filtering capability of 0.5 μm is used.

In the present embodiment, since the circulating system 151 is used together, the density of the UFBs contained in the liquid can be increased by repeating film boiling and ejection operation multiple times on the same liquid. During the collection of the UFB-containing liquid, the liquid is flowed to the collecting container 123 by the switching operation of the valve 62A.

### (Maintenance Mode)

In the present embodiment, as a maintenance mode, the liquid is circulated along the circulating route 152 while the ultraviolet ray radiation by the UV radiating mechanism 128 is performed without applying a voltage to the heating element substrate 134 in the UFB generating unit 121. In this process, the ultraviolet ray radiation by the UV radiating mechanism 153 that is other than the UV radiating mechanism 128 facing the UFB generating unit 121 may be used together.

In a case where the UFB generating apparatus 150 is stopped for long periods, a wetted portion can be sterilized by activating the UFB generating apparatus 150 in the maintenance mode before resuming operation. With this, it is possible to suppress the viable cell contamination of the constituents such as the UFB generating unit 121, the circulating route 152, and the filter 63.

### Third Embodiment

A third embodiment of the present invention is described below with reference to the drawings. Since the basic configuration of the present embodiment is similar to that of the first embodiment, a characteristic configuration is described below.

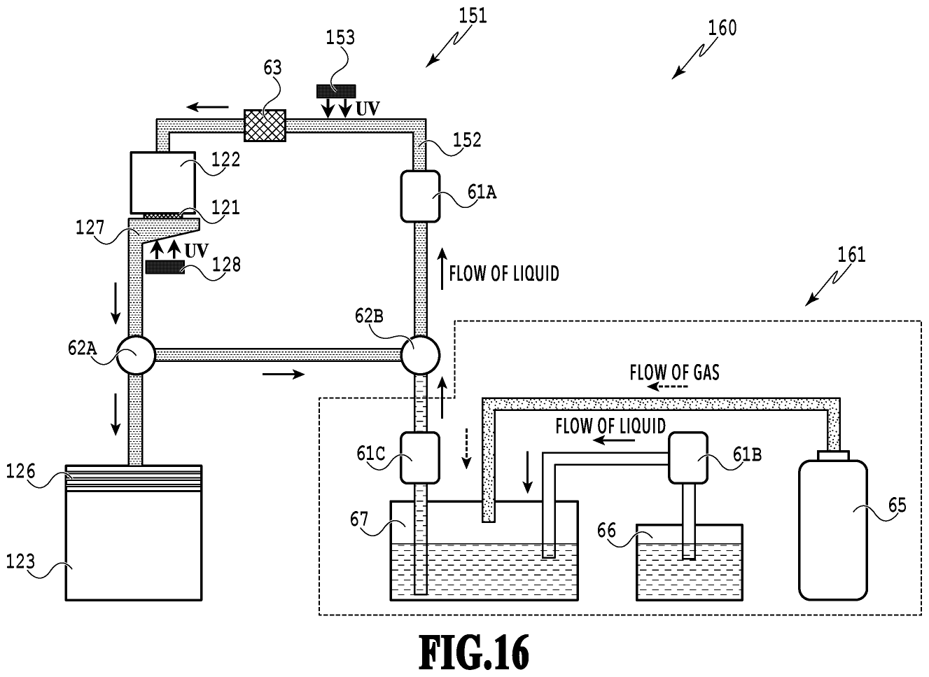

FIG. 16 is a schematic configuration diagram illustrating a UFB generating apparatus 160 in the present embodiment. The UFB generating apparatus 160 has a configuration in which a gas dissolving mechanism (dissolving unit) 161 that dissolves a gas into a liquid is added to the configuration of the UFB generating apparatus 150.

The gas dissolving mechanism 161 includes a gas cylinder 65 in which a desired gas is retained, a liquid supplying tank 66, a gas dissolving tank 67, a pump 61B, and a pump 61C. In order to create a gas dissolving liquid in which a gas is dissolved, first, a gas and a liquid are supplied to the gas dissolving tank 67 from the gas cylinder 65 and the liquid supplying tank 66, respectively. The UFB generating unit 121 of the UFB generating apparatus 160 corresponds to the T-UFB generating unit 300 in FIG. 1. The collecting container 123 corresponds to the post-processing unit 400 or the collecting unit 500 in FIG. 1. The gas dissolving tank 67 corresponds to the dissolving unit 200 in FIG. 1.

In the present embodiment, oxygen is used as the gas dissolved into the liquid. The liquid used is pure water, and the pump 61B is activated to supply the gas dissolving tank 67 with 10 L of the pure water. The temperature of the gas dissolving tank 67 is set to 10° C. by a not-illustrated chiller, oxygen is introduced at a flow rate of about 100 L/min, and bubbling processing is performed in the gas dissolving tank 67 for an hour to dissolve oxygen into the pure water. Subsequently, the pump 61C is activated. Then, by the switching operation of a valve 62B, the gas dissolving liquid is injected into the circulating route 152. The gas dissolving liquid is sterilized by the UV radiating mechanism 153, and thereafter, the gas dissolving liquid passes through the filter 63 and the liquid supplying unit 122, and a UFB-containing liquid based on the oxygen dissolving liquid is generated in the UFB generating unit 121. Description about collecting the UFB-containing liquid is omitted since it is similar to that in the second embodiment.

### Fourth Embodiment

A fourth embodiment of the present invention is described below with reference to the drawings. Since the basic configuration of the present embodiment is similar to that of the first embodiment, a characteristic configuration is described below.

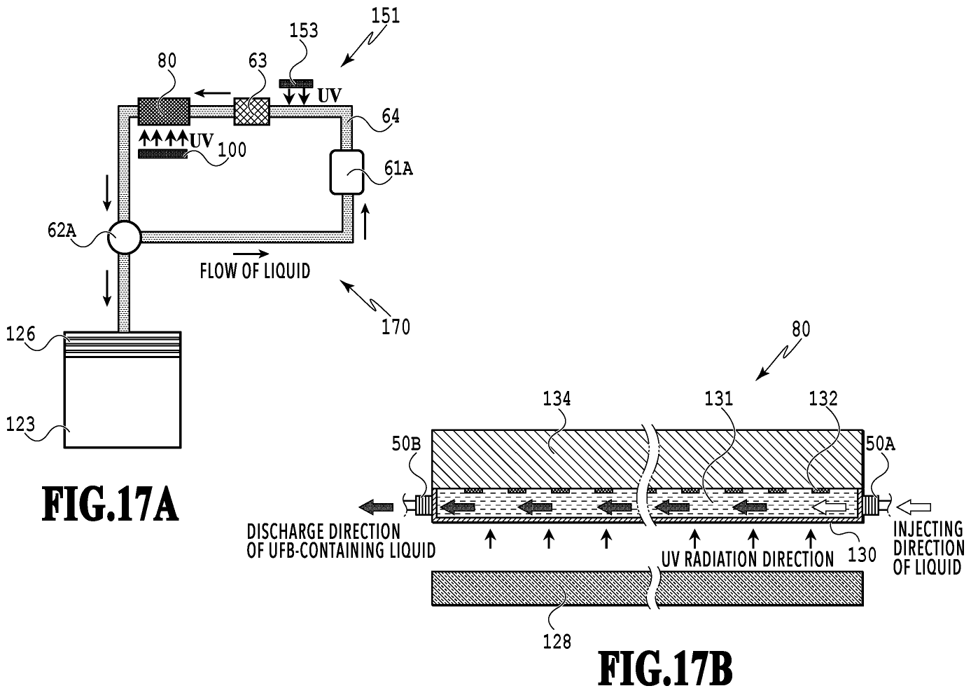

FIG. 17A is a schematic configuration diagram illustrating a UFB generating apparatus 170 in the present embodiment, and FIG. 17B is a diagram illustrating a UFB generating unit 80 in the present embodiment. The UFB generating apparatus 170 has a similar configuration as that of the UFB generating apparatus 150 in the second embodiment but is different in the configuration of the UFB generating unit.

The UFB generating unit 80 in the present embodiment does not include an ejecting port, and the bubbling chamber 131 is provided to cover the heating element substrate 134. The covering member 130 is formed of a transparent member. A coupling 50A and a coupling 50B are provided at two ends of the bubbling chamber 131, and the liquid is injected (flowed) into the UFB generating unit 80 from the coupling 50A, and the UFB-containing liquid generated in the UFB generating unit 80 is discharged (flowed out) from the coupling 50B.

In the present embodiment, film boiling is made in the liquid by an action of the heat energy generating element 132, and, without ejecting the liquid, ultra-fine bubbles (UFBs) are generated in the liquid by generation, growth, shrinkage, and disappearance by the bubbling of an air bubble.

With the UV radiating mechanism 128 irradiating the UFB generating unit 80 with the ultraviolet rays, viable cells that invade the UFB generating unit 80 can be sterilized. With the UV radiating mechanism 153 provided in the circulating system 151 to irradiate the circulating liquid with the ultraviolet rays, the liquid itself is put in a sterilized state.

The maintenance mode in which the ultraviolet ray radiation is performed by the UV radiating mechanism 128 without applying a voltage to the heating element substrate 134 may be set as needed in each of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-068600 filed Apr. 14, 2021, which is hereby incorporated by reference wherein in its entirety.

What is claimed is:

1. An ultra-fine bubble-containing liquid manufacturing apparatus, comprising:
an ultra-fine bubble generating unit that generates an ultra-fine bubble by making film boiling by a heating unit in a liquid in which a gas is dissolved; and
a first radiating unit that is capable of irradiating a wetted portion of the ultra-fine bubble generating unit with ultraviolet rays.

2. The ultra-fine bubble-containing liquid manufacturing apparatus according to claim 1, wherein
the ultra-fine bubble generating unit includes a bubbling chamber that covers the heating unit and an ejecting port that communicates with the bubbling chamber as the wetted portion, and ejects a liquid from the ejecting port.

3. The ultra-fine bubble-containing liquid manufacturing apparatus according to claim 2, wherein
the first radiating unit is provided to radiate the ultraviolet rays toward an ejecting port surface in which the ejecting port of the ultra-fine bubble generating unit is provided.

4. The ultra-fine bubble-containing liquid manufacturing apparatus according to claim 3, wherein
the first radiating unit is provided to face the ejecting port surface.

5. The ultra-fine bubble-containing liquid manufacturing apparatus according to claim 2, wherein
a member forming the ejecting port is a member that allows the ultraviolet rays to pass therethrough.

6. The ultra-fine bubble-containing liquid manufacturing apparatus according to claim 2, further comprising:
a receiving unit that receives the liquid ejected from the ultra-fine bubble generating unit.

7. The ultra-fine bubble-containing liquid manufacturing apparatus according to claim 6, wherein
the receiving unit is a member that allows the ultraviolet rays to pass therethrough.

8. The ultra-fine bubble-containing liquid manufacturing apparatus according to claim 1, further comprising:
a circulating route that circulates the liquid such that the liquid flows out from the ultra-fine bubble generating unit and the liquid also flows into the ultra-fine bubble generating unit.

9. The ultra-fine bubble-containing liquid manufacturing apparatus according to claim 8, further comprising:
a second radiating unit that is capable of irradiating the liquid in the circulating route with ultraviolet rays.

10. The ultra-fine bubble-containing liquid manufacturing apparatus according to claim 9, wherein
the second radiating unit is provided on an upstream side of the ultra-fine bubble generating unit in the circulating route.

11. The ultra-fine bubble-containing liquid manufacturing apparatus according to claim 9, wherein
the second radiating unit radiates ultraviolet rays with a wavelength within a range from 240 nm to 280 nm.

12. The ultra-fine bubble-containing liquid manufacturing apparatus according to claim 9, further comprising:
a filter between a position irradiated by the second radiating unit in the circulating route and the ultra-fine bubble generating unit.

13. The ultra-fine bubble-containing liquid manufacturing apparatus according to claim 9, wherein
a position irradiated by the second radiating unit in the circulating route is formed of a member that allows the ultraviolet rays to pass therethrough.

14. The ultra-fine bubble-containing liquid manufacturing apparatus according to claim 12, wherein
the filter has a filtering capability of 0.5 μm.

15. The ultra-fine bubble-containing liquid manufacturing apparatus according to claim 1, further comprising:
a dissolving unit that dissolves a gas into a liquid, wherein
the liquid supplied from the dissolving unit flows into the ultra-fine bubble generating unit.

16. The ultra-fine bubble-containing liquid manufacturing apparatus according to claim 15, wherein
the dissolving unit dissolves oxygen into a liquid.

17. The ultra-fine bubble-containing liquid manufacturing apparatus according to claim 1, further comprising:
a bubbling chamber that covers the heating unit, wherein
the liquid is supplied to the bubbling chamber as the wetted portion, and
the ultra-fine bubble generating unit causes the liquid to flow out from the bubbling chamber.

18. The ultra-fine bubble-containing liquid manufacturing apparatus according to claim 1, wherein
the first radiating unit radiates ultraviolet rays with a wavelength within a range from 240 nm to 280 nm.

19. The ultra-fine bubble-containing liquid manufacturing apparatus according to claim 1, wherein
the first radiating unit radiates the ultraviolet rays in at least either of a case where the ultra-fine bubble generating unit makes film boiling by the heating unit and a case where the ultra-fine bubble generating unit does not make film boiling by the heating unit.
